(19) United States
(12) Patent Application Publication
(10) Pub. No.: US 2012/0284984 A1
(43) Pub. Date: Nov. 15, 2012

(54) Method of Manufacturing a Handbag

(76) Inventor: Crystal Rena Edgemon, Portland, OR (US)

(21) Appl. No.: 13/467,879

(22) Filed: May 9, 2012

Related U.S. Application Data
(60) Provisional application No. 61/484,051, filed on May 9, 2011.

(51) Int. Cl. B23P 23/00

(52) U.S. Cl. 29/401.1

(57) ABSTRACT

A method includes providing pieces of a beverage container of a desired size. The pieces include opposed side pieces, and a bottom piece. The pieces are laminated and openings are formed around the outer periphery of the pieces. Openings are formed through the outer periphery of opposed flexible sheets. One flexible sheet is laced to the opposed side pieces and the bottom piece at a first end, and the other flexible sheet is laced to the opposed side pieces and the bottom piece at a second end. The opposed side pieces and opposed flexible sheets extend from the outer periphery of the bottom piece, and the bottom piece is opposed to a handbag opening.

### CROSS-REFERENCE TO RELATED APPLICATIONS

This Application claims priority to U.S. Provisional Application No. 61/484,051, which was filed on May 9, 2011, the contents of which are incorporated by reference as though fully set forth herein.

### BACKGROUND OF THE INVENTION

1. Field of the Invention

This invention relates generally handbags, such as purses.

2. Description of the Related Art

It is desired to recycle material, such as metal, glass, paper and cardboard, to reduce the amount of waste. In some situations, the material is recycled and reused in a new product by breaking the material down. In other situations, the material is modified to produce a new product. What is needed are more products that can be manufactured from recyclable material.

### BRIEF SUMMARY OF THE INVENTION

The present invention is directed to a method of manufacturing a purse from recyclable material. The novel features of the invention are set forth with particularity in the appended claims. The invention will be best understood from the following description when read in conjunction with the accompanying drawings.

### BRIEF DESCRIPTION OF THE DRAWINGS

In the drawings, like elements are depicted by like reference numerals. The drawings are briefly described as follows.

FIG. 1 is a perspective view of a handbag.

FIG. 2 is an end view of the handbag of FIG. 1.

FIG. 3 is an opposed perspective view of the handbag of FIG. 1.

FIG. 4 is an opposed side view of the handbag of FIG. 1.

FIG. 5 is a bottom view of the handbag of FIG. 1.

FIG. 6 is a top view of the handbag of FIG. 1.

### DETAILED DESCRIPTION OF THE INVENTION

The invention involves manufacturing a handbag from a recyclable material, such as cardboard. In particular, the handbag is manufactured from cardboard from beverage carriers. Beverages, such as beer and soda, is sometimes sold in a cardboard beverage carriers, which makes it easier to carry a plurality of beverage containers. The beverage container can be of many different types, such as a can and bottle. Examples of beverage carries are disclosed in U.S. Pat. Nos. 3,894,681, 3,904,036, 4,364,509, 4,405,078, 4,588,084, 5,119,985, 5,379,944, 6,131,803, 6,766,940 and 7,743,968, among others.

The method involves providing pieces of the beverage container in a desired size. The cardboard pieces can be provided in many different ways, such as by cutting the beverage container. In one embodiment, opposed side pieces and a bottom piece are provided.

The method involves laminating the cardboard pieces. The cardboard pieces are laminated to make them more resilient against and moisture, as well as normal wear and tear.

Openings are formed around the outer periphery of the cardboard pieces, and eyelets are extended through corresponding openings. The eyelet can include many different materials, such as plastic and metal. It should be noted that the openings and eyelets extend through the lamination.

The method involves forming openings around the outer periphery of a flexible sheet. In this embodiment, two sheets are included, wherein each sheet includes a flexible material. The flexible material can be of many different types, such as those used for garments and personal articles. Garments include shirts and pants, and personal articles include purses, handbags and wallets. Type of flexible material include leather, imitation leather, and synthetic polymers, such as leather and plastic.

The method involves lacing together the various pieces to form the handbag. There are many different ways the pieces can be laced together, such as by using string and rope. In one embodiment, the lacing is done using plastic ties. One type of plastic tie that can be used is often referred to as a cable tie.

In some embodiments, bottle caps are used to form legs on the bottom piece. The legs are useful to protect the bottom piece from becoming damaged and dirty. In some embodiments, the bottle caps are flattened and, in other embodiments, the bottle caps are not flattened. The bottle caps are positioned to operate as legs of the handbag.

In some embodiments, the handbag includes a closure strap to hold the opposed sides together. A magnet can be carried by the closure strap and magnetically coupled to a metal element carried by one side, while the closure strap is coupled to the opposed side. The magnet can be coupled to the closure strap through a bottle cap. The closure strap, magnet and metal element operate as a closure device for the handbag.

In some embodiments, the handbag includes a carrying strap, which allows the handbag to be carried. The carrying strap can be of many different types, such as a leather strap, chain, and ribbon material, among others. The carrying strap can be a shortened strap whose length is chosen so that it can be hand carried. The carrying strap can be a lengthened strap whose length is chosen so that it can be shoulder carried.

It should be noted that the closure strap is typically a flexible strap. The carrying strap can be a flexible strap in some embodiments. In other embodiments, the carrying strap is an inflexible strap. The inflexible strap is rigid, like a plastic handle.

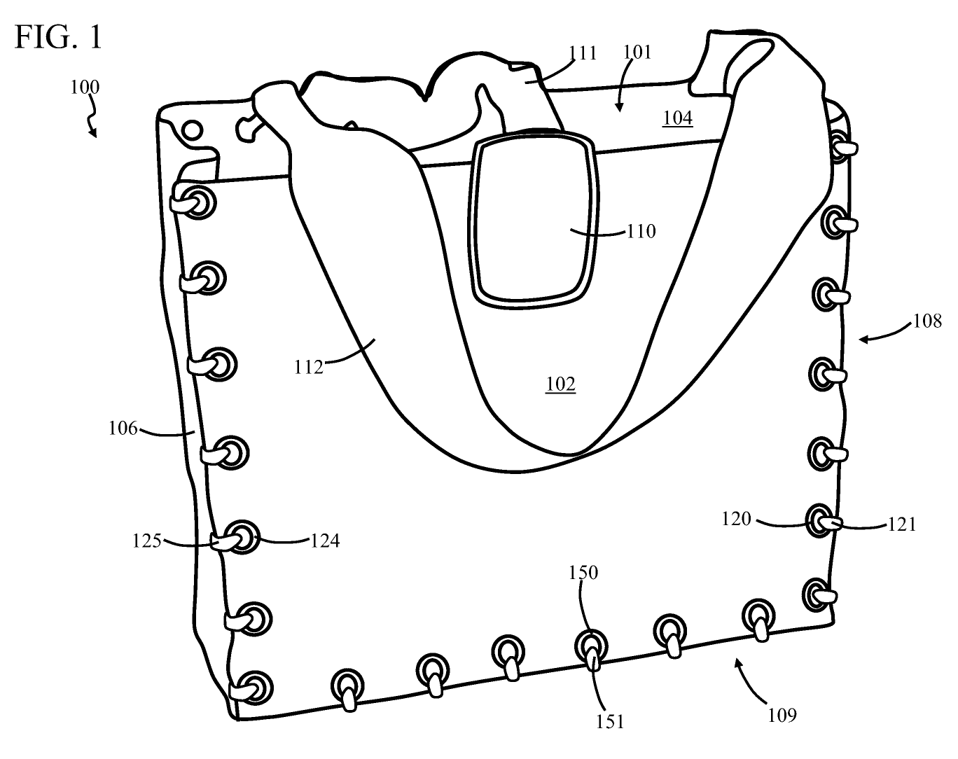

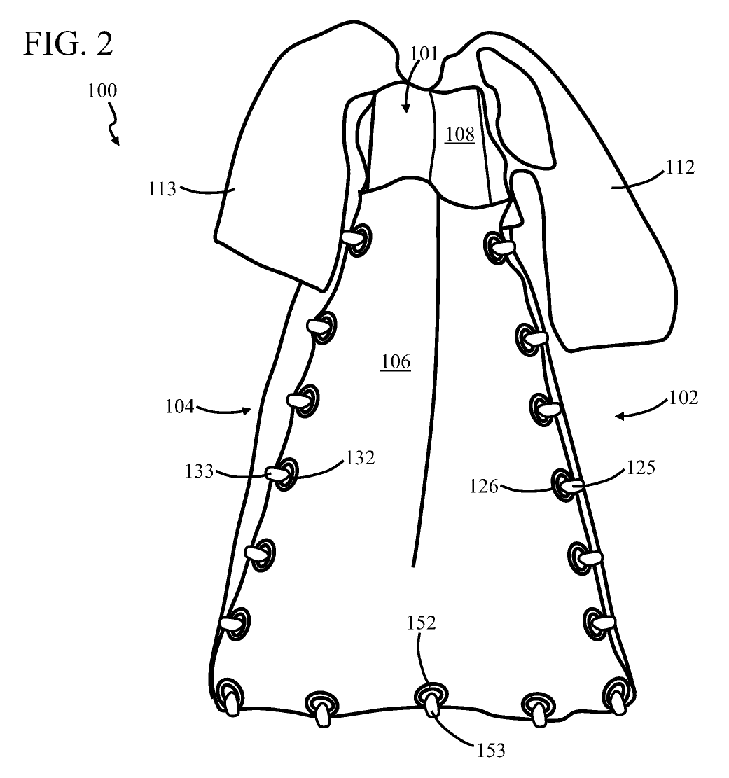

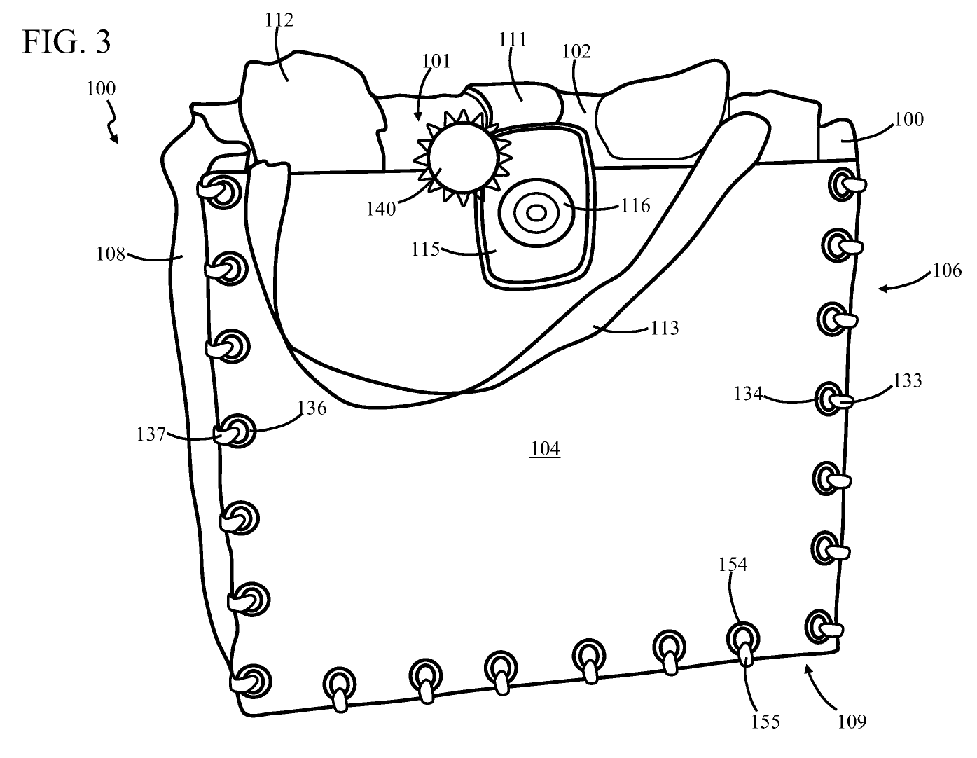

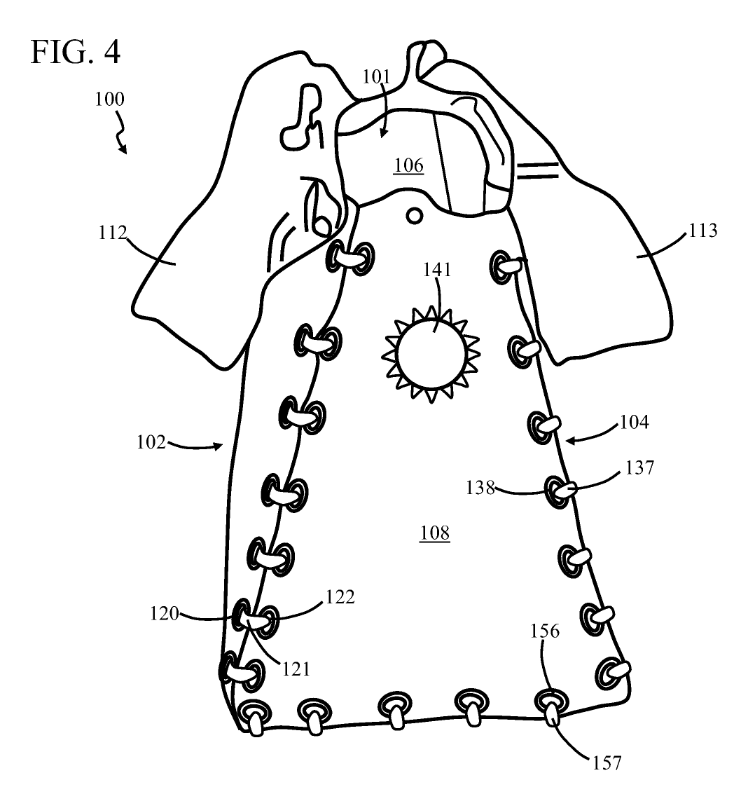

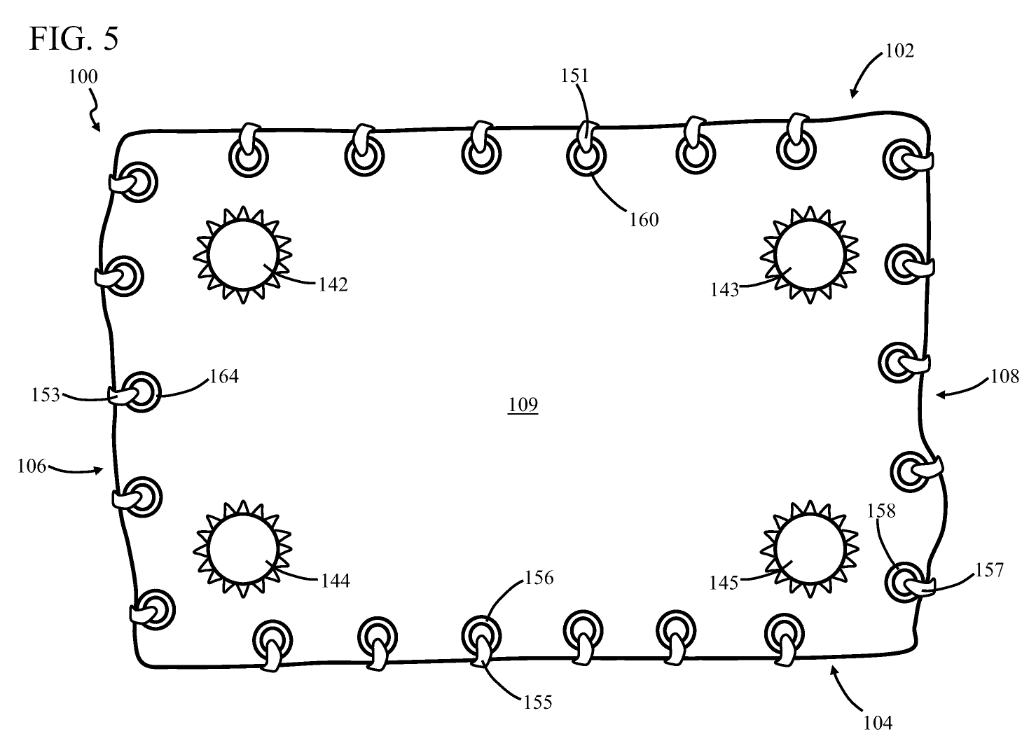

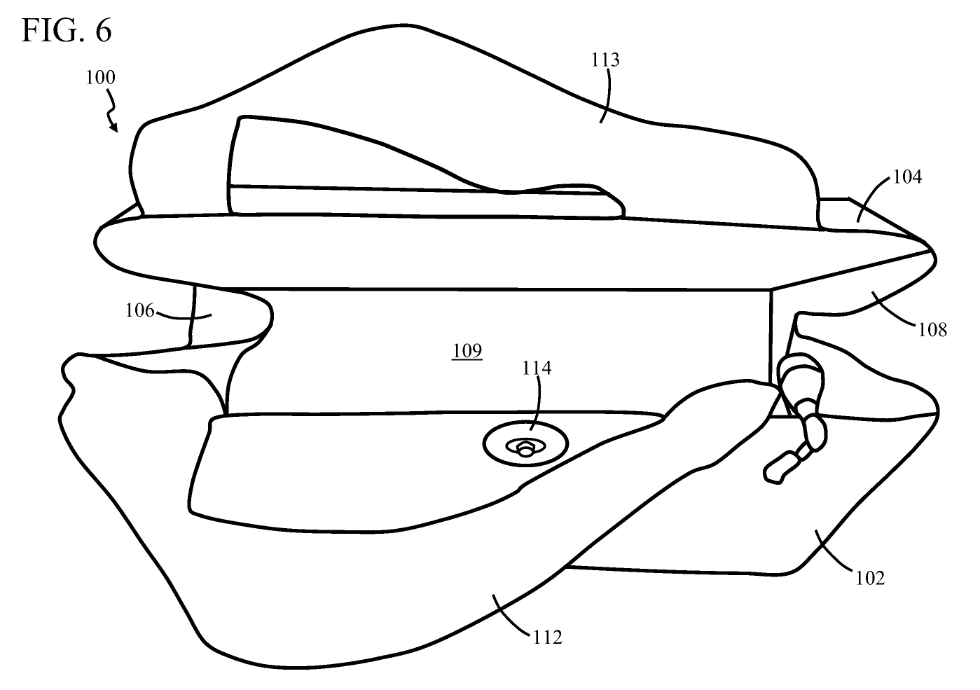

FIGS. 1 and 3 are opposed perspective views of a handbag 100, and FIGS. 2 and 4 are opposed end views of handbag 100. FIG. 5 is a bottom view of the handbag 100, and FIG. 6 is a top view of the handbag 100. In this embodiment, handbag 100 includes a laminated sidewall 102 and opposed laminated sidewall 104. Handbag 100 includes a flexible sheet 106 and opposed flexible sheet 108. Laminated sidewalls 102 and 104 and flexible sheets 106 and 108 bound a handbag opening 101 and extend upwardly from a laminated bottom wall 109. Laminated bottom wall 109 is better seen in FIGS. 5 and 6.

In this embodiment, laminated sidewalls 104 and 106 include portions of a beverage carrier, such as a cardboard beverage carrier. Including portions of the beverage carrier with handbag 100 is useful because is reduces waste since the beverage carriers are typically discarded after use. The portions of the beverage carrier included with sidewalls 104 and 106 is laminated with a protective material. The protective material can be of many different types, such as plastic. The lamination process involves heating the portion of the beverage carrier and the protective material, and pressing them so that they stick together. In some embodiments, one side of the portion of the beverage carrier is laminated and, in other embodiments, both sides of the portion of the beverage carrier are laminated.

In this embodiment, handbag 100 includes handbag handles 112 and 113, which are coupled to laminated sidewalls 102 and 104, respectively. Handbag handles 112 and 113 make it convenient to carry handbag 100. Handbag handles 112 and 113 can include many different materials, such as those disclosed in the above-referenced U.S. Provisional Application. Examples of material of handbag handles 112 and 113 include bamboo, leather and ribbons.

In this embodiment, handbag 100 includes a buckle 110 coupled to a buckle strap 111, wherein buckle strap 111 is coupled to laminated sidewall 104 (FIG. 1) through a buckle 115. Buckle 115 is coupled to an opposed end of buckle strap 111 and laminated sidewall 104 (FIG. 3).

Buckle 110 is repeatably moveable between coupled and uncoupled conditions with a fastener 114, which is shown in FIG. 6. Fastener 114 is coupled to laminated sidewall 102. Handbag opening 101 is repeatably moveable between open and closed conditions in response to moving buckle 110 between coupled and uncoupled conditions, respectively, with fastener 114.

In this embodiment, handbag 100 includes support components carried by laminated bottom wall 109. The support components can be of many different types. In this embodiment, the support components are bottle caps, which are typically used to cap a glass beverage bottle. In this embodiment, handbag 100 includes bottle caps 142, 143, 144 and 145 which are coupled to laminated bottom wall 109, as shown in FIG. 5. It should be noted that handbag 100 can include bottle caps positioned at other locations. For example, in FIG. 3, a bottle cap 140 is positioned proximate to buckle 115 and, in FIG. 4, a bottle cap 141 is positioned at flexible sheet 108. Including bottle caps with handbag 100 is useful because is reduces waste since the bottle caps are typically discarded after use.

The walls of handbag 100 can be coupled together in many different ways. In this embodiment, the walls are laced together. In this embodiment, the walls of handbag 100 are laced together using an eyelet and tie. The tie can be of many different types, such as a plastic tie. Including plastic ties with handbag 100 is useful because is reduces waste since the plastic ties are typically discarded after use.

For example, as shown in FIGS. 1 and 4, handbag 100 includes an eyelet 120, which extends through laminated sidewall 102 (FIG. 1), and an eyelet 122 (FIG. 4), which extends through flexible sheet 108. Handbag 100 includes a tie 121, which extends through eyelets 120 and 122, so that laminated sidewall 102 and flexible sheet 108 are laced together.

As shown in FIGS. 1 and 2, handbag 100 includes an eyelet 124, which extends through laminated sidewall 102 (FIG. 1), and an eyelet 126 (FIG. 2), which extends through flexible sheet 106. Handbag 100 includes a tie 125, which extends through eyelets 124 and 126, so that laminated sidewall 102 and flexible sheet 106 are laced together.

As shown in FIGS. 2 and 3, handbag 100 includes an eyelet 132, which extends through flexible sheet 106 (FIG. 2), and an eyelet 134 (FIG. 3), which extends through laminated sidewall 104. Handbag 100 includes a tie 133, which extends through eyelets 132 and 134, so that laminated sidewalls 104 and flexible sheet 106 are laced together.

As shown in FIGS. 3 and 4, handbag 100 includes an eyelet 136, which extends through laminated sidewall 104 (FIG. 3), and an eyelet 138 (FIG. 4), which extends through flexible sheet 108. Handbag 100 includes a tie 137, which extends through eyelets 136 and 138, so that laminated sidewall 104 and flexible sheet 108 are laced together.

As shown in FIGS. 1 and 5, handbag 100 includes an eyelet 150, which extends through laminated sidewall 102 (FIG. 1), and an eyelet 160 (FIG. 5), which extends through laminated bottom wall 109. Handbag 100 includes a tie 151, which extends through eyelets 150 and 160, so that laminated sidewall 102 and laminated bottom wall 109 are laced together.

As shown in FIGS. 2 and 5, handbag 100 includes an eyelet 152, which extends through flexible sheet 106 (FIG. 2), and an eyelet 164 (FIG. 5), which extends through laminated bottom wall 109. Handbag 100 includes a tie 153, which extends through eyelets 152 and 164, so that flexible sheet 106 and laminated bottom wall 109 are laced together.

As shown in FIGS. 3 and 5, handbag 100 includes an eyelet 154, which extends through laminated sidewall 104 (FIG. 3), and an eyelet 156 (FIG. 5), which extends through laminated bottom wall 109. Handbag 100 includes a tie 155, which extends through eyelets 152 and 164, so that laminated sidewall 104 and laminated bottom wall 109 are laced together.

As shown in FIGS. 4 and 5, handbag 100 includes an eyelet 156, which extends through flexible sheet 108 (FIG. 4), and an eyelet 158 (FIG. 5), which extends through laminated bottom wall 109. Handbag 100 includes a tie 157, which extends through eyelets 156 and 158, so that flexible sheet 108 and laminated bottom wall 109 are laced together.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A method, comprising:
providing pieces of a beverage container in a desired size;
laminating the pieces;
forming openings around the outer periphery of the pieces;
forming openings around the outer periphery of the flexible sheet; and
lacing together the pieces and the flexible sheet to form a handbag.

2. The method of claim 1, wherein the pieces are cardboard pieces.

3. The method of claim 1, wherein the pieces are provided by cutting the beverage container.

4. The method of claim 1, further including extending an eyelet through a corresponding opening.

5. The method of claim 1, wherein the lacing includes extending a plastic tie through an opening.

6. The method of claim 1, further including positioning a bottle cap so it operates as a leg of the handbag.

7. The method of claim 1, further including positioning a closure strap so it operates as a closure device of the handbag.

8. The method of claim 7, further including positioning a magnet so it is carried by the closure strap.
